(19) United States
(12) Patent Application Publication
(10) Pub. No.: US 2011/0023793 A1
(43) Pub. Date: Feb. 3, 2011

(54) Child Tether

(76) Inventor: Casey Marricle, Castle Rock, CO (US)

Correspondence Address: Casey Marricle, P.O. Box 1573, Castle Rock, CO, 80104, US

(21) Appl. No.: 12/511,059

(22) Filed: Jul. 28, 2009

(51) Int. Cl. A01K 27/00

(52) U.S. Cl. 119/770

(57) ABSTRACT

An apparatus for indirectly attaching a person to a supervisor, comprising an intermediate strap and a closed-end loop coupled to one end of the intermediate strap. The closed-end loop is voluntarily coupled to at least one person. An open-loop end is coupled to the other end of the intermediate strap. An attachment device, such as a buckle, carabiner or clip, is coupled to the open-loop end, permitting the apparatus to attach to an article under the supervisor's control.

### FIELD OF THE INVENTION

This invention relates to children's tethers in general, and more specifically, to tethers used to assist small children or other persons in maintaining a close proximity to a supervisor.

### BACKGROUND OF THE INVENTION

Many devices exist to assist in keeping young children or other persons, such as handicapped persons, physically attached to adults or supervisors through harnesses, leashes or other tethering devices. Such devices are normally held by a supervisor. For example, these devices are often held in the supervisor's hand like a dog leash.

On the other end of these restraint devices are one or more involuntary attachments connected to a child. Such attachments are placed around a child's wrist, torso, waist or other body part. These devices use an involuntary restraint such that a child is restrained until the restraint is physically removed from the child by a supervisor. These involuntary restraints are used to prevent children from detaching the restraint from themselves. As such, these restraints are often attached to children with clips, hook and loop fasteners or other attachments types making it difficult or impossible for a child to remove on their own.

A downside to such devices is a need for a supervisor to attach and detach the restraint from a child. Many times a child is old enough or mature enough to not require an involuntary restraint. As such, a passive or voluntary device is needed to overcome the shortcomings of the prior art.

### SUMMARY OF THE INVENTION

In one embodiment of the present invention, an apparatus for indirectly attaching a person to a supervisor is described. The apparatus comprises an intermediate strap and a closed-end loop coupled to one end of the intermediate strap. The closed-end loop is voluntarily coupled to at least one person. An open-loop end is coupled to the other end of the intermediate strap. The open-loop end further has an attachment device, such as, a buckle, carabiner or clip, that is attached to an article under the supervisor's control.

The present invention also discloses a method for making the apparatus. Hence, a method for constructing a child tether comprises the following steps. First, an intermediate strap, a closed-end strap and an open-end strap are provided. The closed-end strap is folded in half and each end of the closed-end strap is positioned above and below one end of the intermediate strap. Next, each end of the closed-end strap is coupled to the first end of the intermediate strap. Next, the open-end strap is folded in half with each end of the open-end strap positioned above and below the other end of the intermediate strap. Each end of the open-end strap is coupled to the second end of the intermediate strap. Lastly, an attachment device is coupled to the open-end loop, permitting the apparatus to couple to an article under the control of a supervisor.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 illustrates a perspective view of a child tether;

FIG. 2 illustrates a macro view of a child tether; and

FIG. 3 illustrates an overhead macro view of a coupling point of a child tether;

FIG. 4A illustrates a perspective view of an open-loop end of a child tether having a buckle coupling;

FIG. 4B illustrates another perspective view of an open-loop end of a child tether having a buckle coupling;

FIG. 4C illustrates a perspective view of an open-loop end of a child tether having a carabiner coupling; and

FIG. 5 is a flow diagram illustrating a method for constructing a child tether.

### DETAILED DESCRIPTION

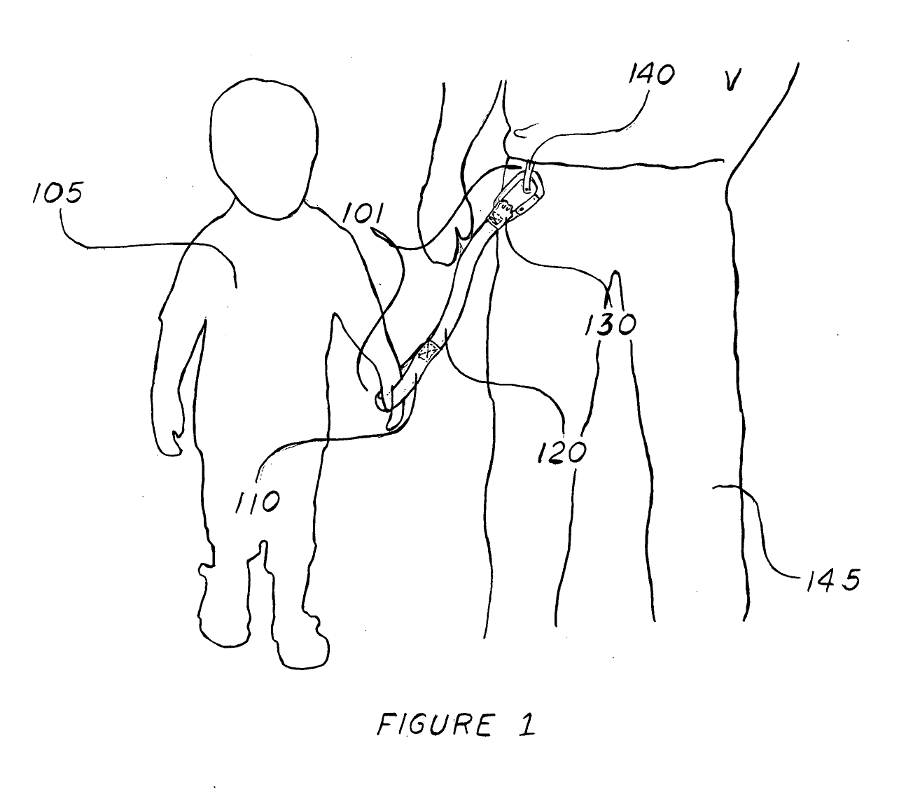

According to several embodiments, the present invention as depicted in FIG. 1 illustrates a perspective view of a child tether 101. Such a child tether 101 may be used to keep one or more persons or children within a close proximity to a supervisor or adult without requiring the person or child to be involuntarily attached to the child tether.

A child 105, voluntarily holds a closed-loop end 110 in their hand. The closed-loop end 110 is coupled to one end of an intermediate strap 120. A supervisor, such as an adult 145, maintains an open-loop end 130 that is attached to an article under the control of the adult 145. In an example, the open-loop 130 may be attached to the adult's 145 belt loop 140. The open-loop end 130 is coupled to the other end of the intermediate strap 120. In this embodiment, the child 105 remains within a close proximity to the adult 145 by voluntarily holding the closed-loop end 110 of the child tether 101. While the open-loop end 130 of the child tether 101 is attached to an article under the control of the adult 145. In one embodiment, an open-loop end 130 may be defined as a way for the end to be opened and closed, permitting the loop to be attached to an article. Examples are further described below.

In one embodiment, the child 105 may be a toddler or small child. In another embodiment, the child 105 may include an adult that may require assistance in remaining in a close proximity to an adult, such as a physically or mentally handicapped person. In another embodiment, a supervisor may include any person responsible for the child 105.

In one embodiment, an article under the control of an adult may include, but is not limited to, both articles attached to an adult or articles indirectly in contact with an adult. In one embodiment, articles attached directly to the adult may include: a belt, a belt loop, suspenders, a wristwatch, and the like. In another embodiment, articles indirectly in contact with an adult may include: a handbag or purse, a backpack, a stroller, a briefcase, a shopping cart, and the like. In other words, the open loop end 130 of the child tether 101 may be coupled to any of the above examples of articles under the control of an adult. In another embodiment, the open loop end 130 may be held in the hand of an adult without directly coupling the open loop end 130 to an article. It should be noted, that the above examples are merely a subset and should not be construed to be encompassing of all possible articles under the control of an adult.

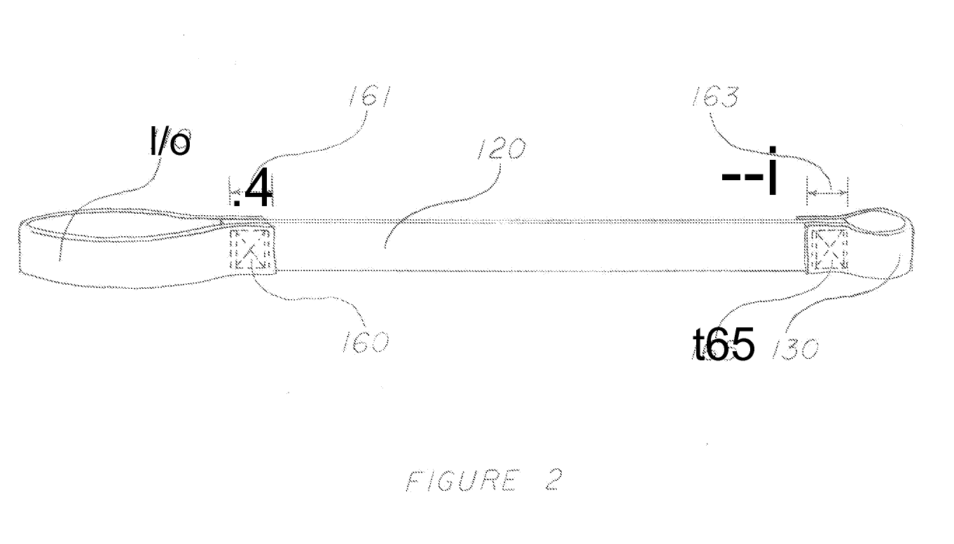

FIG. 2 illustrates a macro or close up view of the child tether 101. As shown in FIG. 1, the child tether 101 comprises a closed-loop end 110, an intermediate strap 120 and an open-loop end 130. In one embodiment, the intermediate strap 120 is made from differing materials such as polypropylene, nylon, neoprene, cloth, rubber, chain, and the like. In another embodiment, the intermediate strap 120 may exhibit elastic characteristics permitting the strap to stretch beyond its resting length. In yet another embodiment, the intermediate strap 120 may have a length ranging between 10 and 30 inches. However, both shorter and longer lengths may be employed without deviating from the scope of the invention. In yet another embodiment, the intermediate strap is roughly one inch wide. However, both shorter and longer widths may be employed.

In one embodiment, both closed-loop end 110 and open-loop end 130 may be constructed from the same or differing materials as the intermediate strap 120. Also each looped end may also exhibit elastic characteristics as mentioned in regards to the intermediate strap 120. As previously stated, closed-loop end 110 may normally be held in a child's hand. As such, the closed-loop end 110 may consist of a loop coupled to the intermediate strap 120 at coupling point 160.

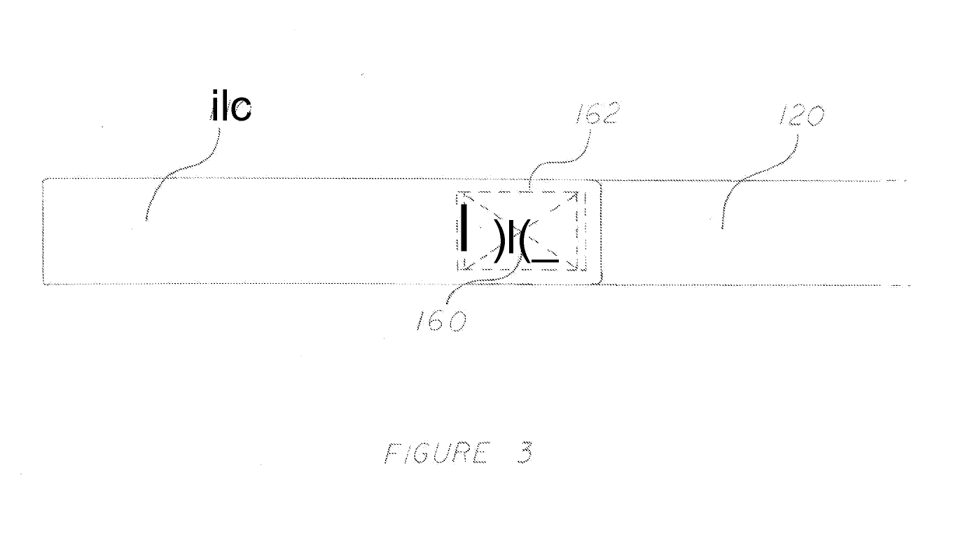

In conjunction with FIG. 2, FIG. 3 illustrates an overhead macro view of one embodiment of a coupling point 160. The intermediate strap 120 may be folded in half and sandwiched between each end of the closed-loop end 110, creating three layers of material. These layers may be held together with stitching 162 using materials known by those skilled in the art. In one embodiment, each end of the closed-end loop 110 may overlap 161 the intermediate strap by roughly one to two inches.

In another embodiment, the coupling point 160 may be held together by other means such as adhesives, hook and loop fasteners or by bonding the three layers together through heating and melting the layers together. Coupling point 165, which is used to couple the open-end loop 130 to the intermediate strap 120, may employ similar coupling methods and characteristics as described in regards to coupling point 160.

Returning to FIG. 2, the closed-end loop 110 may consist of a single strap of material with a length between 6 and 18 inches. Such a length may be varied to provide a proper diameter to permit holding by both a small child's hand and a large adult's hand. In one embodiment, the length of the closed-end loop 110 is roughly eleven inches.

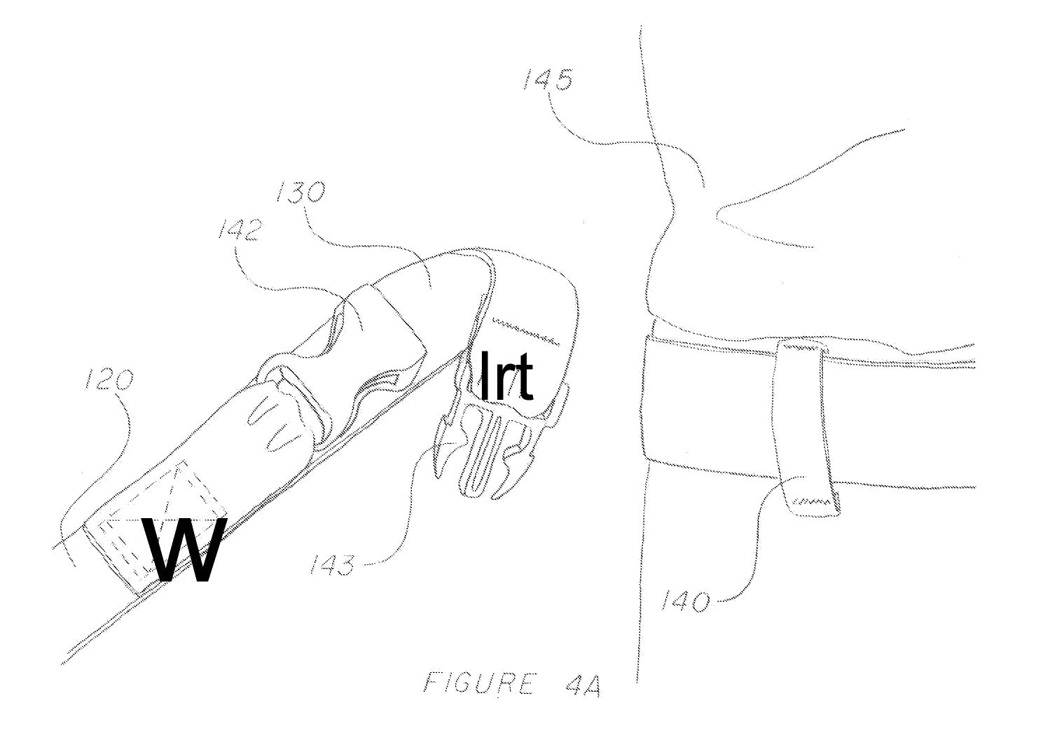

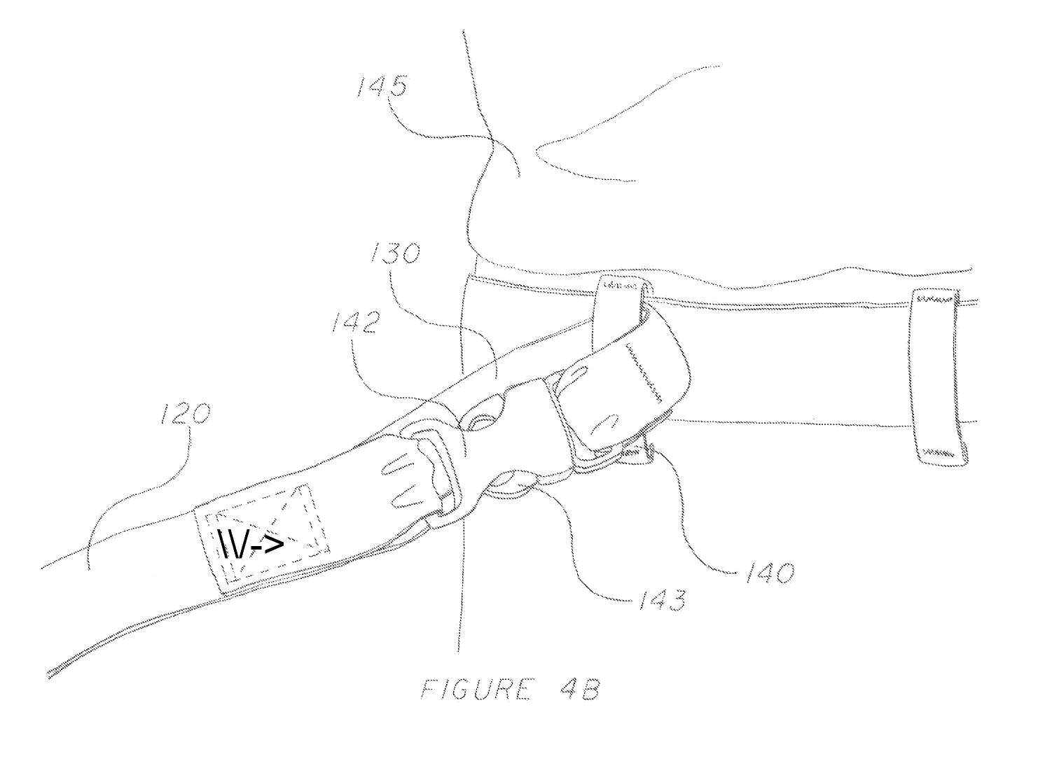

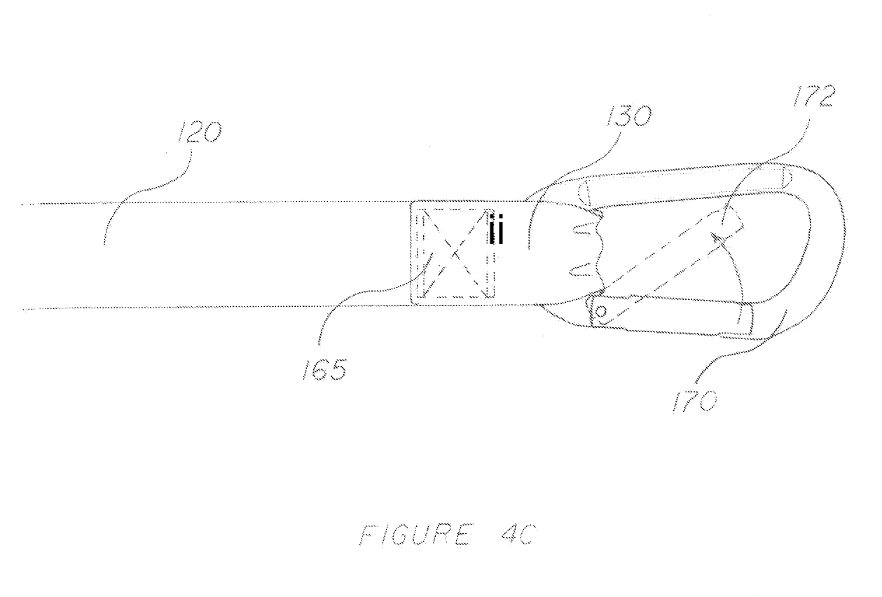

As previously described, open-loop end 130 may be attached to an article under the control of a supervisor 145. As such, the open-loop end 130 should be capable of opening in some way to permit attaching to such an article. In one embodiment, the open-loop end 130 resembles a similar structure to the closed-loop end 110 by having a strap of material with a break in the middle that may be opened and closed to surround an article such as a belt loop, handbag, etc. In one embodiment, the open-loop end may be opened and closed by a hook and loop fasteners such as VELCRO™, thus allowing a supervisor 145 to attach the open-loop end 130 to a preferred article. FIGS. 4A and 4B illustrate a perspective view of the open-loop end 130 in both open and closed positions. In these figures, a buckle is employed to couple the child tether to an article under the control of the supervisor. In FIG. 4A a portion of intermediate strap 120 is shown as coupled to open-loop end 130. Open-loop end 130 is in an open position surrounding, but not yet attached around the belt loop 140 of the supervisor 145. A female buckle end 142 is coupled to one of the open ends of open-loop end 130. A male buckle end 143 is coupled to the other end of the open-loop end 130. FIG. 4B shows the open-loop end 130 having been closed around and attached to the supervisor's 145 belt loop 140. This is done by the male buckle end 143 being inserted into the female buckle end 142.

In another embodiment, as shown in FIG. 4C, the open-loop end 130 employs a different attachment in the form of a carabiner 170. Such an attachment permits the supervisor 145 to clip the attachment through the open-loop end 130 and the article under the control of the supervisor. The carabiner 170 is clipped into the open-loop end 130 of the child tether. The carabiner 170 is also shown in an open position 172. Other types of attachments may be used, as the examples provided are not meant to be exclusive.

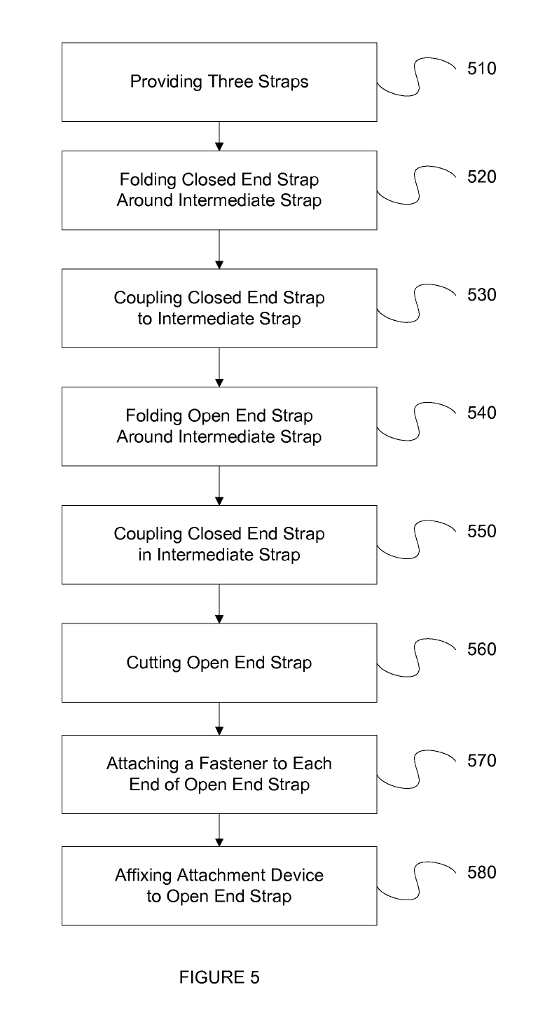

FIG. 5 is a flow diagram illustrating a method for constructing a child tether as described above. First, an intermediate strap, a closed end strap and an open end strap are provided (step 510). Next, the closed end strap is folded in half with the two ends being placed above and below a first end of the intermediate strap (step 520). Hence, the first end of the intermediate strap is sandwiched between the two ends of the closed end strap. This arrangement is illustrated as coupling 160 in FIG. 2. In one embodiment, the two ends of the closed end strap overlap the first end of the intermediate strap as further shown as overlap 161 of coupling 160 of FIG. 2. Next, the three layers are coupled together (step 530). In one embodiment, and as shown in stitching 162 of FIG. 3, the three layers may be stitched together. In other embodiments, the three layers may be held together by hook and loop fasteners, adhesive or heat. Next, the open end strap is folded in half with the two ends being placed above and below the second end of the intermediate strap (step 540). Hence, the second end of the intermediate strap is sandwiched between the two ends of the open end strap. This arrangement is illustrated as coupling 165 in FIG. 2. In one embodiment the two ends of the open end strap overlap the second end of the intermediate strap as further shown as overlap 163 in FIG. 2. Thereafter, the three layers are coupled together (step 550). In one embodiment, step 550 uses the same or substantially similar coupling methods as described in regards to step 530.

In one embodiment, the open end strap is cut open (step 560) such that the open end strap no longer forms a permanently closed loop. Further, hook and loop fasteners may be attached to each end of the open end strap (step 565). This permits the open end loop to be opened, fitted around an article and then reattached to provide a bond with the article.

Additionally, or in the alternative to steps 560 and 565, an attachment device may be affixed to the open end strap (step 570) as a means for attaching the open end strap to an article. In one embodiment, the attachment device may be a buckle, a carabiner, a clip or the like.

What is claimed is:

1. An apparatus for indirectly attaching a person to a supervisor, comprising:
an intermediate strap;
a closed-end loop coupled to a first end of the intermediate strap, the closed-end loop being voluntarily coupled to at least one person;
an open-loop end coupled to a second end of the intermediate strap; and
an attachment device coupled to the open-loop end, the attachment device being coupled to an article under the supervisor's control.

2. The apparatus of claim 1, wherein the closed-loop end is held in a hand of the at least one person.

3. The apparatus of claim 1, wherein the attachment device consists of hook and loop fasteners

4. The apparatus of claim 1, wherein the attachment device is a carabiner.

5. The apparatus of claim 1, wherein the article under the control of the supervisor is selected from the group consisting of: a belt, a belt loop, a stroller, a shopping cart, a hand bag, and a backpack.

6. The apparatus of claim 1, further comprising an adjustment device attached to and placed along a length of the intermediate strap, the adjustment device to permit the length of the intermediate strap to adjust.

7. The apparatus of claim 1, wherein at least a portion of the child tether is made from a material selected from the group consisting of: polypropylene, nylon, neoprene, cloth, rubber, rope and chain.

8. The apparatus of claim 1, wherein at least one of the loop ends are coupled to the intermediate strap with stitching, hook and loop fasteners or adhesive.

9. A method for constructing a child tether, comprising the steps of:
providing an intermediate strap, a closed-end strap and an open-end strap;
folding the closed-end strap in half and positioning each end of the closed-end strap above and below a first end of the intermediate strap;
coupling each end of the closed-end strap to the first end of the intermediate strap;
folding the open-end strap in half and positioning each end of the open-end strap above and below a second end of the intermediate strap; and
coupling each end of the open-end strap to the second end of the intermediate strap.

10. The method of claim 10, further comprising:
coupling an attachment device to the open end strap.

11. The method of either claim 10, further comprising:
cutting through the open end strap; and
attaching hook and loop fasteners to each end of the open end strap.

12. The method of claim 10, wherein the attachment device is selected from the group consisting of: a carabiner, a buckle and a clip.

13. The method of claim 10, wherein at least one portion of the apparatus is made from a material selected from the group consisting of: polypropylene, nylon, neoprene, rubber, cloth, rope and chain.

14. The method of claim 10, further comprising attaching an adjustment device to the intermediate strap to permit adjustments to the length of the intermediate strap.
